(19) United States
(12) Patent Application Publication
(10) Pub. No.: US 2026/0346730 A1
(43) Pub. Date: Nov. 5, 2026

(54) BATTERY CONTROL APPARATUS AND NON-TRANSITORY RECORDING MEDIUM

(71) Applicant: SUBARU CORPORATION, Tokyo (JP)

(72) Inventors: Ryo KIKKAWA, Tokyo (JP); Satoshi YOSHIZAWA, Tokyo (JP)

(21) Appl. No.: 19/712,673

(22) Filed: Jun. 18, 2026

Related U.S. Application Data
(63) Continuation of application No. PCT/JP2024/000421, filed on Jan. 11, 2024.

(51) Int. Cl. B60L 7/18; B60L 15/20

(52) U.S. Cl. CPC B60L 7/18; B60L 15/2009; B60L 15/2045; B60L 2240/545

(57) ABSTRACT

A battery control apparatus includes at least one processor, and at least one memory storing a program to be executed by the processor. The processor calculates an estimated regeneration value of a regenerative current amount to be supplied to a battery of a vehicle in a downward zone of a gradient continuous section, tentatively determines a discharging current amount to be discharged from the battery in an upward zone of the gradient continuous section with a value of current flowing from the battery before the vehicle enters the gradient continuous section set as an initial current value, and determines a limit value of the discharging current amount in a non-downward zone by adjusting the initial current value, based on a temperature rise value of the battery in the gradient continuous section. The temperature rise value is determined based on the estimated regeneration value thus calculated and the discharging current amount.

### CROSS REFERENCE TO RELATED APPLICATIONS

This application is continuation of International Application No. PCT/JP2024/000421, filed on Jan. 11, 2024, the entire contents of which are hereby incorporated by reference.

### BACKGROUND

The disclosure relates to a battery control apparatus and a non-transitory recording medium containing a battery control program.

A vehicle including an electric motor (hereinafter referred to as an “electric vehicle”) configured to be driven by electric power supplied from a battery includes a battery control apparatus that controls charging and discharging of the battery. The battery control apparatus monitors the temperature of the battery in the vehicle, and if it is estimated that the temperature of the battery in the vehicle will exceed an upper limit temperature of a predetermined operational range, controls the temperature of the battery by limiting the charging and discharging.

For example, on an upward slope that necessitates a higher output than a flat road does, the amount of electric power discharged from the battery can increase, and a battery cell tends to increase in temperature due to heat generation by internal resistance. To address this, a battery charging and discharging control apparatus disclosed in, for example, Japanese Unexamined Patent Application Publication (JP-A) No. 2012-116411 limits the charging and discharging of the battery, based on a reference value that is lower than a normal upper limit temperature of the battery when an upward slope is determined to be present in front of the vehicle, based on a road condition in front of the vehicle.

Further, a charging and discharging control apparatus disclosed in, for example, JP-A No. 2019-41460 determines whether the temperature of a battery mounted in a vehicle is higher than or equal to a predetermined temperature during traveling of the vehicle, limits charging of the battery when the temperature of the battery is higher than or equal to a threshold A, and limits both charging and discharging of the battery when the temperature of the battery is higher than or equal to a threshold B that is higher than the threshold A.

### SUMMARY

An aspect of the disclosure provides a battery control apparatus configured to be applied to a vehicle. The battery control apparatus is configured to perform charging and discharging control of a battery mounted in the vehicle in a gradient continuous section including one or more upward zones and one or more downward zones. The battery control apparatus includes one or more processor, and one or more memory configured to store a program to be executed by the one or more processors. The one or more processors are configured to: calculate an estimated regeneration value of a regenerative current amount to be supplied to the battery in the downward zone of the gradient continuous section; tentatively determine a discharging current amount to be discharged from the battery in a non-downward zone that is included in the gradient continuous section and different from the one or more downward zones, with a value of current flowing from the battery before the vehicle enters the gradient continuous section set as an initial current value; and determine a limit value of the discharging current amount in the non-downward zone by adjusting the initial current value, based on a temperature rise value of the battery in the gradient continuous section. The temperature rise value of the battery is determined based on the estimated regeneration value thus calculated and the discharging current amount.

An aspect of the disclosure provides a non-transitory computer readable recording medium containing a computer program that causes, when executed by a computer, the computer to implement a method. The method includes: calculating an estimated regeneration value of a regenerative current amount to be supplied to a battery mounted in a vehicle in a downward zone of a gradient continuous section including one or more upward zones and one or more downward zones; tentatively determining a discharging current amount to be discharged from the battery in a non-downward zone that is included in the gradient continuous section and different from the one or more downward zones, with a value of current flowing from the battery before the vehicle enters the gradient continuous section set as an initial current value; and determining a limit value of the discharging current amount in the non-downward zone by adjusting the initial current value, based on a temperature rise value of the battery in the gradient continuous section. The temperature rise value of the battery is determined based on the estimated regeneration value thus calculated and the discharging current amount.

### BRIEF DESCRIPTION OF THE DRAWINGS

The accompanying drawings are included to provide a further understanding of the disclosure and are incorporated in and constitute a part of this specification. The drawings illustrate embodiments and, together with the specification, serve to explain the principles of the disclosure.

FIG. 1 is a schematic diagram illustrating an exemplary configuration of an electric vehicle according to one example embodiment of the disclosure.

FIG. 2 is a functional block diagram of the electric vehicle illustrated in FIG. 1.

FIG. 3 is a functional block diagram of a battery control apparatus and peripheral devices mounted in the electric vehicle illustrated in FIG. 1.

FIG. 4 is a schematic diagram illustrating an example of a gradient continuous section according to one example embodiment of the disclosure.

FIG. 5 is a schematic diagram illustrating forces exerted on the vehicle when the vehicle travels on a downward slope.

FIG. 6 is a flowchart of a battery control method according to one example embodiment of the disclosure.

FIG. 7 is a schematic diagram illustrating a current map on which an estimated regeneration value to be received by the battery during traveling on a downward zone of the gradient continuous section is reflected.

FIG. 8 is a schematic diagram illustrating a current map on which a discharging current value to be discharged from the battery in a non-downward zone of the gradient continuous section is further reflected.

FIG. 9 is a schematic diagram illustrating a relation between a change in temperature of the battery in the gradient continuous section and an upper limit temperature, based on the estimated regeneration value and a discharging current amount, in a case where the temperature of the battery reaches the upper limit temperature during traveling in the gradient continuous section.

FIG. 10 is a schematic diagram illustrating a current map in a case of downward adjustment of the discharging current value in the non-downward zone.

FIG. 11 is a schematic diagram illustrating an estimated relation between a change in temperature of the battery in the gradient continuous section and the upper limit temperature after the downward adjustment of the discharging current value.

FIG. 12 is a schematic diagram illustrating a relation between a change in temperature of the battery in the gradient continuous section and the upper limit temperature, based on the estimated regeneration value and the discharging current amount, in a case where the temperature of the battery does not reach the upper limit temperature.

FIG. 13 is a schematic diagram illustrating a current map in a case of upward adjustment of the discharging current value in the non-downward zone.

FIG. 14 is a schematic diagram illustrating a relation between a change in temperature of the battery in the gradient continuous section and the upper limit temperature after the upward adjustment of the discharging current value.

FIG. 15 is a schematic diagram illustrating forces exerted on the vehicle when the vehicle travels on an upward zone of the gradient continuous section.

FIG. 16 is a schematic diagram illustrating a current map in a case of downward adjustment of a regenerative current amount (charging) in the downward zone.

FIG. 17 is a schematic diagram illustrating another example of the gradient continuous section according to one example embodiment of the disclosure.

FIG. 18 is a schematic diagram illustrating a current map in a case of upward adjustment of the discharging current value in the non-downward zone.

### DETAILED DESCRIPTION

Existing techniques, such as charging and discharging control apparatuses disclosed in JP-A Nos. 2012-116411 and 2019-41460 described above, still have difficulties in appropriately satisfying market needs and have some problems described below.

The charging and discharging control apparatuses disclosed in JP-A Nos. 2012-116411 and 2019-41460 described above are configured to perform battery temperature control so that a battery temperature is prevented from reaching an upper limit temperature on an upward slope. However, these existing charging and discharging control apparatus disclosed in, for example, JP-A Nos. 2012-116411 and 2019-41460 are designed to perform the charging and discharging control of the battery simply assuming the presence of an upward slope and are not designed to maximize a regenerative current amount during traveling on a downward slope.

According to the existing techniques, in an example situation where a vehicle travels in a gradient continuous section including an upward slope (an upward zone) and a downward slope (a downward zone) and where the battery temperature reaches the upper limit temperature after the vehicle finishes traveling on the upward slope, the battery temperature can exceed the upper limit temperature due to charging by regenerative braking on the downward slope located after the upward slope. This can make it difficult to use the regenerative braking generated on the downward slope as a braking force, resulting in waste of electric energy generated by the regenerative braking.

It is desirable to provide a battery control apparatus and a non-transitory recording medium each of which makes it possible to perform charging and discharging control of a battery of a vehicle economically and effectively in traveling in the gradient continuous section described above.

In the following, some example embodiments of the disclosure are described in detail with reference to the accompanying drawings. Note that the following description is directed to illustrative examples of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiments which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same reference numerals to avoid any redundant description. In addition, elements that are not directly related to any embodiment of the disclosure are unillustrated in the drawings. Further, configurations other than those described in detail below may be implemented by adding additional elements or configurations related to an electric vehicle according to known techniques including JP-A Nos. 2012-116411 and 2019-41460 described above, as appropriate.

### Electric Vehicle 100

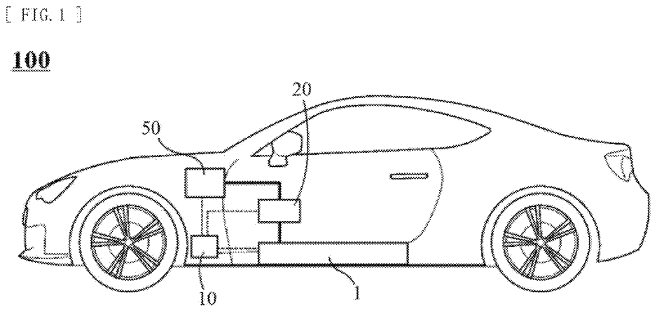

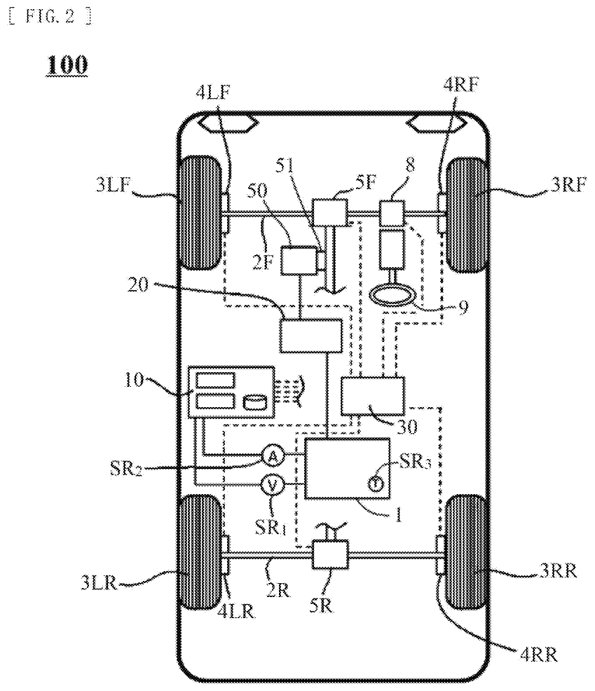

FIGS. 1 and 2 each schematically illustrate an exemplary configuration of an electric vehicle 100 according to an example embodiment of the disclosure. The electric vehicle 100 according to the present example embodiment may be various kinds of known electric vehicles driven by electric motors, such as an electric vehicle, a hybrid electric vehicle (HEV), or a plug-in hybrid vehicle (PHEV) configured to include a battery 1 described below. Further, the battery 1 according to the present example embodiment may be various kinds of secondary battery, such as a lithium-ion secondary battery or a nickel-hydrogen battery.

Referring to FIG. 1, the electric vehicle 100 may be configured to supply electric power from the battery 1 to an electric motor 50 via a known converter 20 under the control of the battery control apparatus 10. In the present example embodiment, the converter 20 may include a known AC/DC converter or a known DC/AC converter that performs conversion between a direct current and an alternating current, and a known DC/DC converter that adjusts a direct-current voltage value to a desired voltage value.

Referring to FIG. 2, the electric vehicle 100 may be, for example, a four-wheel vehicle that transmits driving torque outputted from the electric motor 50 that generates vehicle driving torque to a left-front wheel 3LF, a right-front wheel 3RF, a left-rear wheel 3LR, and a right-rear wheel 3RR (hereinafter collectively referred to as “driving wheels 3” when these wheels are not to be distinguished from one another). In the present example embodiment, the electric motor 50 may be, but not limited thereto, a known electric motor disclosed in JP-A No. 2012-116411 or 2019-41460 described above. The electric motor 50 may be configured to output driving torque to be transmitted to a front-wheel driving shaft 2F via a known transmission 51 and a known front-wheel differential mechanism 5F, and to a rear-wheel driving shaft 2R via the known transmission 51 and a known rear-wheel differential mechanism 5R.

In the present example embodiment, the driving torque may be distributed to the driving wheels 3 by the single electric motor 50; however, in some embodiments, respective electric motors 50 may be provided on a front-wheel side and a rear-wheel side, or respective electric motors 50 may be provided to the driving wheels 3. In the present example embodiment, the electric vehicle 100 may be a four-wheel vehicle as described above; however, in some embodiments, the electric vehicle 100 may be a two-wheel vehicle having a front wheel and a rear wheel that are driven by the electric motor described above.

The electric motor 50 may be electrically coupled to the battery 1 via the converter 20 described above. The battery control apparatus 10 may be configured to perform control that causes the battery 1 to supply electric power (a discharging current) necessary to drive the electric motor 50 via the converter 20, and causes the battery 1 to be charged with the electric power (regenerative current) generated by the electric motor 50 upon regeneration via the converter 20. In other words, the battery 1 according to the present example embodiment may possibly generate heat during traveling of the electric vehicle 100 by supplying the discharging current to the electric motor 50 via the converter 20 described above and receiving the regenerative current from the electric motor 50 via the converter 20.

In the present example embodiment, the electric vehicle 100 may include a known electric steering device 8 and known braking devices 4LF, 4RF, 4LR, and 4RR (hereinafter collectively referred to as “braking devices 4” when these braking devices are not to be distinguished from one another), as equipment to be used for vehicle driving control. In the present example embodiment, the front-wheel driving shaft 2F may be provided with the electric steering device 8 described above. The electric steering device 8 may include a known motor and a known gear that are not illustrated in the drawings and necessary to drive the electric steering device 8. The electric steering device 8 may adjust steered angles of the left-front wheel 3LF and the right-front wheel 3RF by being controlled by a vehicle control ECU 30.

Such a vehicle control ECU 30 may be a single unit provided in the vehicle or multiple units separately provided in the vehicle. In some embodiments, the vehicle control ECU 30 may be a single known electronic control unit (ECU) or multiple known ECUs that control the electric motor 50, the electric steering device 8, the steering wheel 9, and the braking devices 4, for example.

The battery control apparatus 10 may be one of the ECUs described above or may include one or more processors (central processing units (CPUs)) and one or more memories communicably coupled to the one or more processors. Further, the battery control apparatus 10 may be coupled to a known external network NT such as the Internet via a known communication device CD such as a smartphone-assisted communicator or an in-vehicle communicator. Such a battery control apparatus 10 may be electrically coupled to the communication device CD described above, sensors SR, a memory device MD such as a known hard disk or a known SSD, a notifier PD including a known speaker and a known display DP, and other components, directly or via an in-vehicle communication means such as a controller area network (CAN) or a local interconnect network (LIN).

The sensors SR may include a known voltage sensor SR₁, a known current sensor SR₂, and a known battery temperature sensor SR₃. The voltage sensor SR₁ may be configured to detect a voltage value of the battery 1 described above. The current sensor SR₂ may be configured to detect a current value of the battery 1 described above. The battery temperature sensor SR₃ may be configured to detect a temperature of the battery 1 during traveling of the vehicle. In the present example embodiment, the sensors SR may further include any other known in-vehicle sensors such as a vehicle speed sensor, an imaging sensor, and a gyroscope sensor, in addition to the sensors described above.

### Exemplary Configuration of Battery Control Apparatus 10

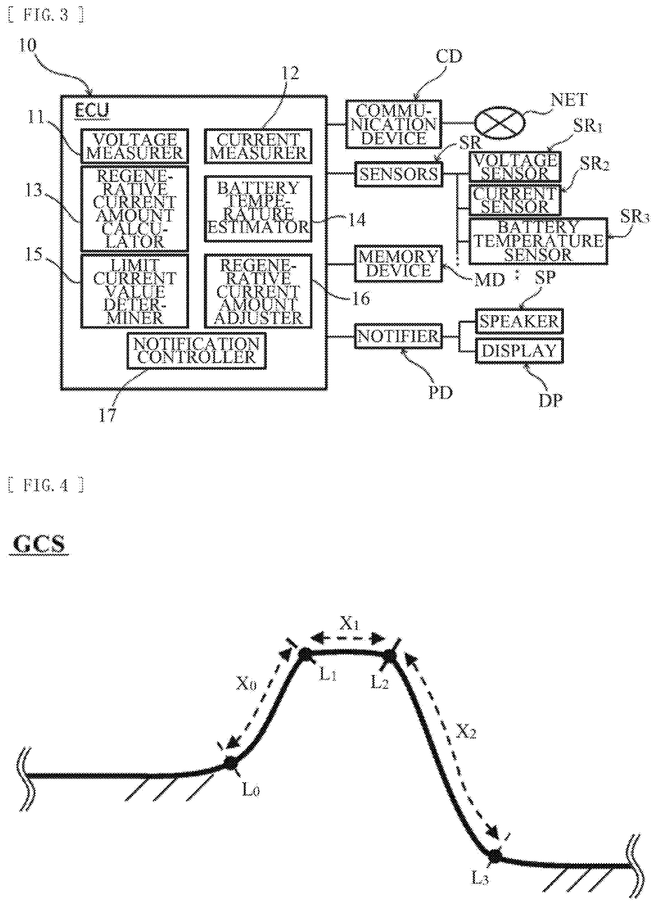

FIG. 3 illustrates an exemplary configuration including the battery control apparatus 10 and peripheral devices.

As described above, the battery mounted in the electric vehicle 100 may possibly generate heat due to charging or discharging during traveling of the electric vehicle 100. Such a battery 1 may be operatable in a use temperature range so defined that the designed performance is secured. A road on which the electric vehicle 100 is to travel may include an upward slope and a downward slope each having a predetermined gradient. In one embodiment, the upward slope may serve as an “upward zone”. In one embodiment, the downward slope may serve as a “downward zone”. For example, when the electric vehicle 100 travels in a section including the upward zone and the downward zone, it is desirable to perform the charging and discharging control of the battery so that necessary acceleration is achieved on the upward slope and that a regenerative current is effectively obtained on the downward slope.

Taking into consideration these circumstances, the battery control apparatus 10 according to the present example embodiment is configured to perform the charging and discharging control so that the temperature of the battery 1 is prevented from reaching the upper limit value in the section including the upward zone and the downward zone and that regenerative electric power is collected as much as possible during traveling on the downward zone.

In the present example embodiment, the section in which the electric vehicle 100 including the battery control apparatus 10 is to travel may be referred to as a “gradient continuous section GCS”. The gradient continuous section GCS may include an upward zone including one or more upward slopes and a downward zone including one or more downward slopes. In some embodiments, the gradient continuous section GCS may further include a flat road zone in addition to the upward zone and the downward zone.

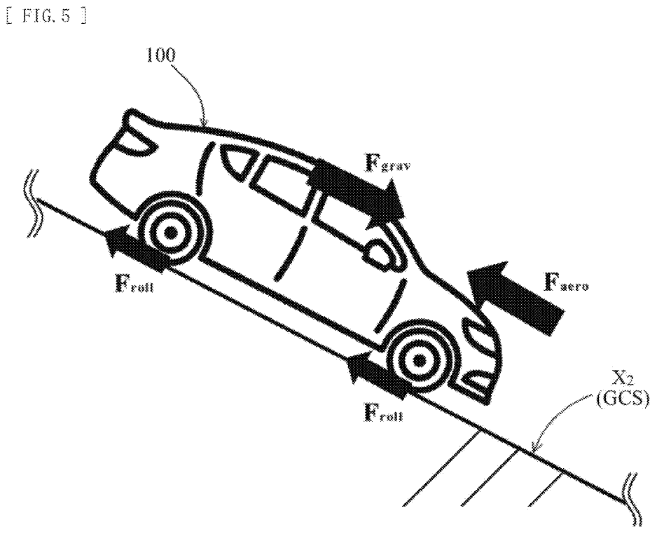

FIG. 4 illustrates an example of the gradient continuous section GCS. The gradient continuous section GCS illustrated in FIG. 4 may be a road including an upward zone X₀, a flat road zone X₁, and a downward zone X₂. The upward zone X₀ may be an upward slope extending from a point L₀ to a point L₁. The flat road zone X₁ may be a flat road extending from the point L₁ to a point L₂. The downward zone X₂ may be a downward slope extending from the point L₂ to a point L₃.

The term “upward zone” used herein may refer to a road having an upward slope angle greater than or equal to a predetermined reference angle θth,up relative to a horizontal plane and having a length of several ten meters to several kilometers. In other words, the upward zone may have such an inclination angle that a vehicle traveling in the zone with the accelerator pedal off decelerates at a deceleration rate greater than a predetermined value determined in advance in an experiment, for example. Further, the term “downward zone” used herein may refer to a road having a downward slope angle greater than or equal to a predetermined reference angle θth,down relative to the horizontal plane and having a length of several ten meters to several kilometers. In other words, the downward zone may have such an inclination angle that a vehicle traveling in the zone with the accelerator pedal off accelerates in an inclined direction of the zone.

These predetermined reference angles θth,up and θth,down may be set to respective values different from each other or may be set to respective values identical to each other. The term “flat road zone” used herein may refer to a road other than the upward zone and the downward zone described above, and may have a slope angle less than the predetermined reference angle θth,up in an upward direction relative to the horizontal plane and a slope angle less than the reference angle θth,down in a downward direction relative to the horizontal plane. Such slope angles may be detected by a known inclination sensor disclosed in, for example, JP-A No. 2002-96721. Further, the predetermined reference angles θth,up and θth,down and the lengths of the zones may be appropriately determined in an experiment or simulation. The upward slope and the downward slope may be determined based on a predetermined criteria by a known method other than those described above.

Hereinafter, the upward zone and the flat road zone of the gradient continuous section GCS may be also collectively referred to as a “non-downward zone”.

The battery control apparatus 10 includes a processor and a memory configured to store a program to be executed by the processor. The processor is configured to calculate an estimated regeneration value of a regenerative current amount to be supplied to the battery 1 in the downward zone of the gradient continuous section GCS, tentatively determine, as an initial current value, a discharging current amount to be discharged from the battery 1 in the non-downward zone of the gradient continuous section GCS, and determine a limit value of the discharging current amount in the non-downward zone by adjusting the initial current value based on a temperature rise value of the battery 1 in the gradient continuous section GCS. The temperature rise value of the battery is determined based on the estimated regeneration value thus calculated and the discharging current amount.

A description will be given in detail below of the exemplary configuration of the battery control apparatus 10.

### Functional Block of Battery Control Apparatus 10

Referring to FIG. 3, the battery control apparatus 10 according to the present example embodiment may include a voltage measurer 11, a current measurer 12, a regenerative current amount calculator 13, a battery temperature estimator 14, a limit current value determiner 15, a regenerative current amount adjuster 16, and a notification controller 17.

### Voltage Measurer 11

The voltage measurer 11 may be configured to measure a voltage value of the battery 1 via the voltage sensor SR₁ described above. In some embodiments, the voltage measurer 11 may be configured to measure the voltage value of the battery 1 at a predetermined timing in order to drive the electric motor 50 during traveling of the electric vehicle 100.

### Current Measurer 12

The current measurer 12 may be configured to measure a current value of the battery 1 via the current sensor SR₂ described above. In some embodiments, the current measurer 12 may be configured to measure the value of current flowing in the battery 1 during traveling of the electric vehicle 100.

### Regenerative Current Amount Calculator 13

The regenerative current amount calculator 13 is configured to calculate the estimated regeneration value of the regenerative current amount to be supplied to the battery 1 in the downward zone of the gradient continuous section GCS in which the electric vehicle 100 is planned to travel. In some embodiments where a traveling route is set by an in-vehicle navigator, the gradient continuous section GCS in which the electric vehicle 100 is planned to travel may be extracted as a part of the traveling route. In some embodiments where the traveling route is not set, the gradient continuous section GCS may be extracted from a route whose distance is defined substantially uniformly, such as a route on a highway, as appropriate.

FIG. 5 schematically illustrates forces exerted on the electric vehicle 100 traveling on a downward slope at a constant speed. Note that the following description is given by way of an example in which the electric vehicle 100 travels on a downward slope at a constant speed in order to simplify the description; however, an example in which the electric vehicle 100 travels on a downward slope at a non-constant speed may be employed using another known calculation expression or conversion equation.

When the electric vehicle 100 travels on the downward slope (e.g., the downward zone X₂) as illustrated in FIG. 5, various forces may be exerted on the electric vehicle 100. Non-limiting examples of the forces exerted on the electric vehicle 100 may include rolling resistance Froll applied from a road surface to the wheels of the electric vehicle 100, air resistance Faero exerted on the electric vehicle 100, and gravity Fgrav exerted on the electric vehicle 100.

A braking force Fbrake to be generated by the wheels of the electric vehicle 100 to cause the electric vehicle 100 to travel on the downward slope at a constant speed may be calculated by the following Expression 1:

Fbrake=|Fgrav|−|Froll|−|Faero| Expression 1

Note that, in Expression 1 described above, an acceleration force generated by the gravity may be assumed to be greater than the traveling resistances, as described below.

|Fgrav|>|Froll|+|Faero|

Braking torque Tbrake necessary for the electric motor 50 of the electric vehicle 100 may be calculated by the following Expression 2, based on a wheel radius and a speed ratio of the electric vehicle 100 that are each previously known:

Tbrake =Fbrake ×Wheel Radius/Speed Ratio Expression 2

Assuming that the braking torque Tbrake thus calculated is to be generated by the electric motor 50, a current to flow in the battery 1 due to a regeneration operation via the electric motor 50 may be calculated backward using a known circuit model and a known battery model.

Note that the regenerative current amount calculator 13 may calculate the above-described estimated regeneration value in the downward zone of the gradient continuous section GCS, by a known method disclosed in, for example, JP-A No. 2020-141439 or 2021-078217, instead of the method described above.

### Battery Temperature Estimator 14

The battery temperature estimator 14 may be configured to calculate the temperature of the battery 1 and a change in the temperature of the battery 1 in the gradient continuous section GCS in which the electric vehicle 100 is planned to travel. In some embodiments, the battery temperature estimator 14 may be configured to calculate a temperature Tcell of the battery 1, based on a current value (an initial current value Inow or a revised current value Irev) determined by the limit current value determiner 15 described below, by the following method.

For example, the battery temperature estimator 14 may calculate, based on the initial current value Inow, the change in the temperature of the battery 1 in a case of discharging from the battery 1 in the non-downward zone of the gradient continuous section GCS, using the following Expression 3:

Ccell×(dTcell/dt)=Qs+Qj−Qrad Expression 3

The parameters Qs, Qj, and Qrad may be calculated by the following Expressions 4, 5, and 6, respectively.

Qs=Tcell ×ΔS×(I/F) Expression 4

Qj=R×I² Expression 5

Qrad=hcell×Acell×(Tcell−Tamb) Expression 6

In the expressions described above, “Ccell” may represent a specific heat of the battery 1, “Qs” may represent heat generation and heat absorption associated with chemical reactions (charging and discharging) of the battery 1, “Qj” may represent heat generation by Joule heat associated with energization of the battery 1, “Qrad” may represent heat dissipation of the battery 1 to the surroundings, “ΔS” may represent an entropy change, “F” may represent a Faraday constant, “I” may represent a value of current flowing in the battery 1, “R” may represent an internal resistance of the battery 1, “hcell” may represent a heat conduction coefficient, “Acell” may represent a surface area of the battery 1, and “Tamb” may represent a surrounding temperature of the battery 1. These constant values related to physical properties of the battery 1 may be determined in advance in an experiment or simulation. Variables such as the surrounding temperature of the battery 1 may be acquired by a known in-vehicle sensor.

Note that the battery temperature estimator 14 may calculate the change in the temperature Tcell of the battery 1, by a known method disclosed in, for example, JP-A No. 2006-139963 or 2022-171118, instead of the method described above.

### Limit Current Value Determiner 15

The limit current value determiner 15 is configured to tentatively determine, as the initial current value Inow, the discharging current amount (current value) to be discharged from the battery 1 in the non-downward zone of the gradient continuous section GCS. In some embodiments, the initial current value Inow used by the limit current value determiner 15 may be the value of current flowing from the battery 1 before the electric vehicle 100 enters the gradient continuous section GCS. In some embodiments, the initial current value Inow may be a predetermined constant current value of, for example, 200 A or 300 A.

The limit current value determiner 15 is configured to determine the limit current value of the discharging current amount in the non-downward zone, based on the temperature rise value of the battery 1 in the gradient continuous section GCS, using a predetermined calculation expression usable for adjusting the initial current value Inow. The temperature rise value of the battery 1 is determined based on the estimated regeneration value calculated by the regenerative current amount calculator 13 and the discharging current amount estimated by the battery temperature estimator 14, as described above.

In some embodiments, the limit current value determiner 15 may determine the limit value of the discharging current amount in the non-downward zone, using a predetermined calculation expression including the initial current value Inow revised by adding or subtracting a predetermined current value (ΔI described below) to/from the initial current value Inow, as described below. In some embodiments, the limit current value determiner 15 may determine the limit value of the discharging current amount in the non-downward zone, using a predetermined calculation expression including the initial current value Inow revised by multiplying the initial current value Inow by a predetermined coefficient α, as described below.

### Regenerative Current Amount Adjuster 16

When the gradient continuous section GCS includes a non-downward zone where an estimated traveling speed is lower than a minimum speed legally prescribed, the regenerative current amount adjuster 16 may perform control that relaxes the limit value of the discharging current amount in the non-downward zone in cooperation with the limit current value determiner 15 and reduces the regenerative current amount in the downward zone of the gradient continuous section GCS.

### Notification Controller 17

The notification controller 17 may perform a process of notifying various kinds of information such as a charging and discharging state of the battery 1 in the gradient continuous section GCS via the notifier PD including the speaker SP and the display DP described above. In some embodiments, the notification controller 17 may perform the control that notifies an occupant of the electric vehicle 100 of the various kinds of information via the notifier PD disposed in the electric vehicle 100 or by accessing an external terminal such as a smartphone owned by the occupant.

### Battery Control Method

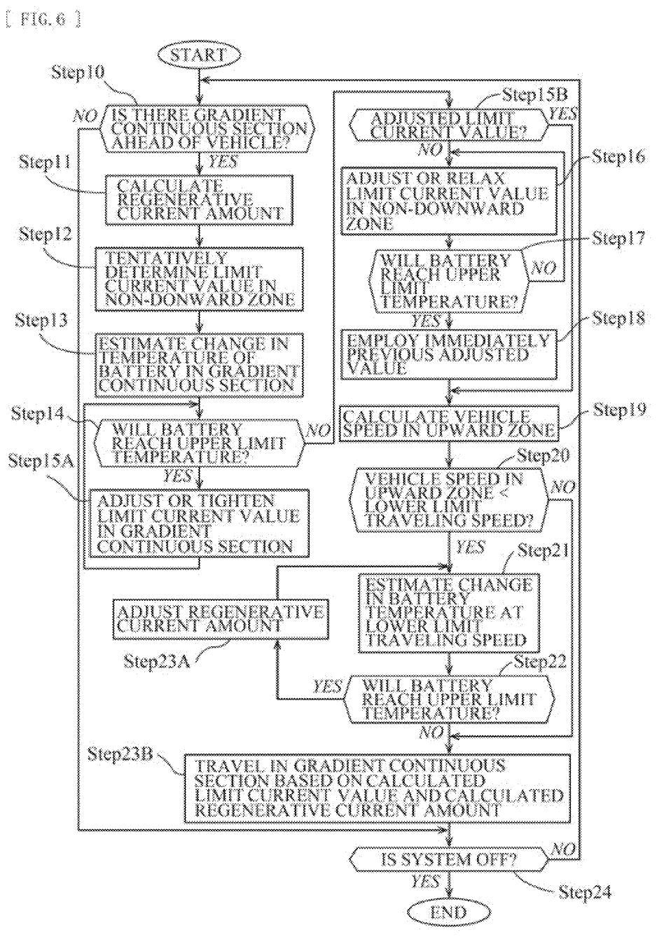

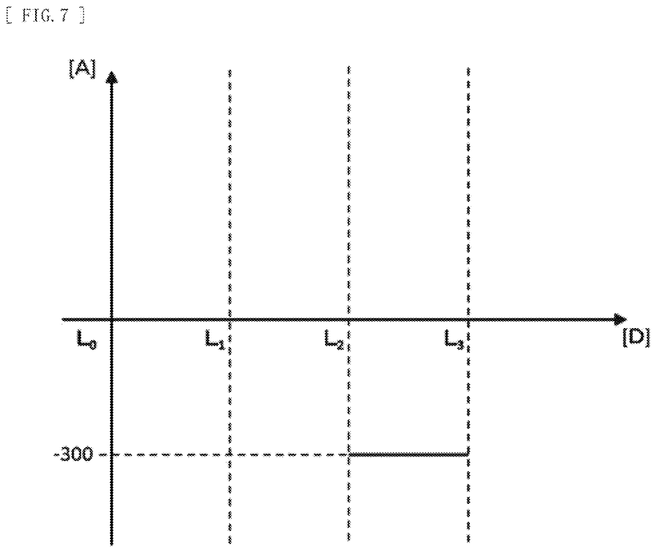

Next, a battery control method executable by the battery control apparatus 10 according to the present example embodiment will be described with reference to FIGS. 6 to 16. As described above, the battery control method according to the present example embodiment may be implemented in the form of a program, and the program may be stored in a known recording medium.

In the following, a description is given of the charging and discharging control of the battery 1 to be performed when the electric vehicle 100 including the battery control apparatus 10 described above passes through the gradient continuous section GCS including one or more upward zones and one or more downward zones as illustrated in FIG. 4.

For example, the electric vehicle 100 may be planned to travel in the gradient continuous section GCS located on the traveling route through the following zones in order: the upward zone X₀ from the point L₀ to the point L₁, the flat road zone X₁ from the point L₁ to the point L₂, and the downward zone X₂ from the point L₂ to the point L₃. In this case, the battery control apparatus 10 may execute a later-described process included in the battery control method before the electric vehicle 100 enters the gradient continuous section GCS (e.g., several ten meters to several kilometers before the point L₀), for example.

With reference to FIG. 6, in Step 10, the battery control apparatus 10 may determine whether the gradient continuous section GCS is located ahead of the electric vehicle 100 during traveling. In some embodiments where the traveling route of the electric vehicle 100 is set by the navigator as described above, the battery control apparatus 10 may determine whether the gradient continuous section GCS is located ahead of the electric vehicle 100 on the traveling route.

If it is determined in Step 10 that no gradient continuous section GCS is located ahead of the electric vehicle 100 (Step 10: NO), the procedure may proceed to Step 24. If it is determined in Step 24 that the system of the electric vehicle 100 is not off (Step 24: NO), the procedure may return to Step 10, and Step 10 may be repeated.

If it is determined in Step 10 that the gradient continuous section GCS is located ahead of the electric vehicle 100 (Step 10: YES), the procedure may proceed to Step 11.

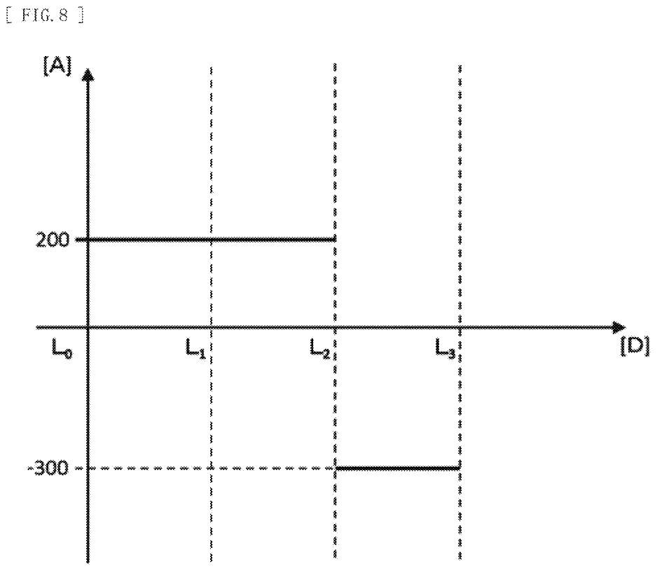

In Step 11, the regenerative current amount calculator 13 of the battery control apparatus 10 may calculate the estimated regeneration value of the regenerative current amount to be supplied to the battery 1 in the downward zone X₂ of the gradient continuous section GCS, as described above. At this time, as illustrated in FIG. 7, for example, the regenerative current amount calculator 13 may calculate the estimated regeneration value (a value of charging current to flow in the battery 1) in the downward zone X₂ to be 300 A (amperes).

After the estimated regeneration value in the downward zone X₂ is calculated in Step 11, the limit current value determiner 15 of the battery control apparatus 10 may tentatively determine, in Step 12, a discharging current amount to be discharged from the battery 1 in the non-downward zone (in this example, the upward zone X₀ and the flat road zone X₁) of the gradient continuous section GCS as the initial current value Inow.

In some embodiments, the limit current value determiner 15 may tentatively determine the value of current flowing from the battery 1 before the electric vehicle 100 enters the gradient continuous section GCS (e.g., several ten meters to one kilometer before the point L₀ described above) as the initial current value Inow. When a current of 200 A flows in the battery 1 before the electric vehicle 100 enters the gradient continuous section GCS, for example, the limit current value determiner 15 may tentatively determine that the initial current value Inow to be 200 A. The discharging current amount to be discharged from the battery 1 in the non-downward zone (e.g., the upward zone X₀ and the flat road zone X₁) of the gradient continuous section GCS may be thereby tentatively determined to be 200 A, as illustrated in FIG. 8. Note that, in the present example embodiment, the initial current value Inow may be any predetermined value calculated in advance in an experiment or simulation, instead of the value described above.

Thereafter, in Step 13, the battery temperature estimator 14 of the battery control apparatus 10 may estimate a change in temperature of the battery 1 in the gradient continuous section GCS, based on the discharging current amount and the estimated regeneration value in the gradient continuous section GCS calculated at or before Step 12, through the method described above. Thereafter, in Step 14, the battery control apparatus 10 may determine whether the temperature of the battery 1 will reach a predetermined upper limit temperature Tmax in the gradient continuous section GCS. Note that the value of the upper limit temperature Tmax may be determined in advance in an experiment or simulation in accordance with the type or specification of the battery 1 in use.

### Downward Adjustment of Limit Current Value

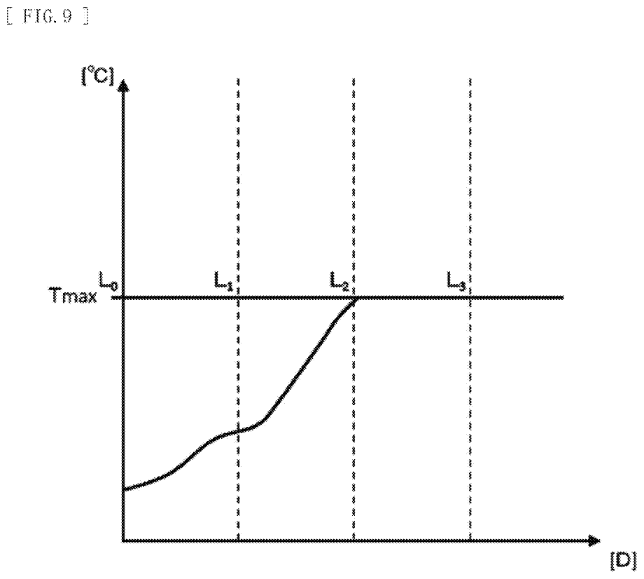

If it is determined in Step 14 that the battery 1 will reach the upper limit temperature Tmax in the gradient continuous section GCS as in a case illustrated in FIG. 9, for example (Step 14: YES), the procedure may proceed to Step 15A in which a process of adjusting (tightening) the limit current value in the non-downward zone is executed as described below.

In some embodiments, the limit current value determiner 15 may substitute the initial current value Inow for a reference value Ibase in the following predetermined Expression 7, and cause a predetermined amount of current value ΔI to be subtracted from the reference value Ibase to thereby calculate the revised current value Irev.

Irev=Ibase−ΔI Expression 7

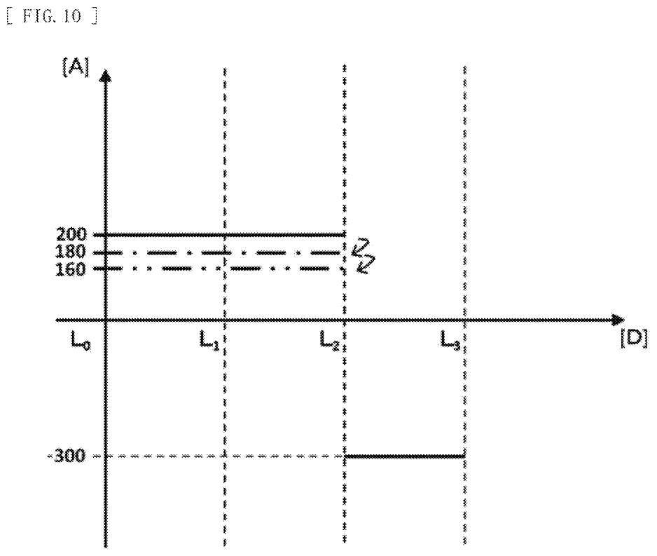

In some embodiments as illustrated in FIG. 10, the limit current value determiner 15 may adjust the discharging current amount from the initial current value Inow of 200 A set as the reference value Ibase to 180 A lower than the reference value Ibase by 20 A that corresponds to the current value ΔI, as indicated by a dashed-dotted line. Note that the current value ΔI may be any predetermined fixed value, such as 20 A or 15 A, or may be a variable that changes in accordance with repeated execution of Step 15A.

After the discharging current amount is adjusted in Step 15A, the procedure may return to Step 14, and the battery control apparatus 10 may determine again whether the temperature of the battery 1 will reach the upper limit temperature Tmax in the gradient continuous section GCS, based on the discharging current amount downwardly adjusted. In some embodiments, the battery temperature estimator 14 may estimate a change in temperature of the battery 1 again, based on the discharging current value downwardly adjusted to 180 A.

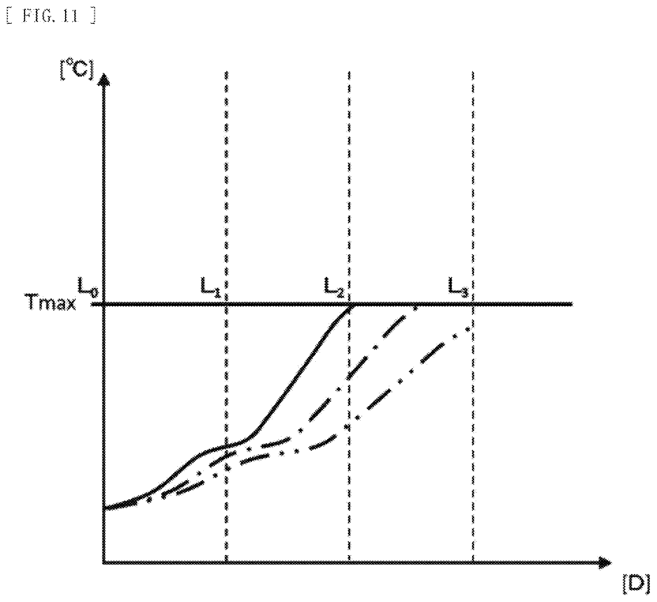

In Step 14, the battery control apparatus 10 may determine again whether the temperature of the battery 1 will reach the upper limit temperature Tmax, based on the discharging current amount downwardly adjusted (180 A). In this case, as indicated by a dashed-dotted line illustrated in FIG. 11, it may be determined that the temperature of the battery 1 will reach the upper limit temperature Tmax (Step 14: YES), even based on the discharging current amount adjusted to 180 A; therefore, the battery control apparatus 10 may repeat the above-described process at Step 15A again.

The limit current value determiner 15 may adjust the discharging current amount again from 180 A, which is the discharging current amount having been adjusted as the reference value Ibase, to 160 A, which is lower than the reference value Ibase by 20 A that corresponds to the current value ΔI, as indicated by a dashed-two dotted line in FIG. 10.

After the discharging current amount is adjusted again in Step 15A, the procedure may return to Step 14, and the battery control apparatus 10 may determine again whether the temperature of the battery 1 will reach the upper limit temperature Tmax in the gradient continuous section GCS, based on the discharging current amount downwardly adjusted (160 A in this example). In this case, as indicated by a dashed-two dotted line illustrated in FIG. 11, it may be determined that the temperature of the battery 1 will not reach the upper limit temperature Tmax in the gradient continuous section GCS (Step 14: NO), based on the discharging current amount adjusted to 160 A; therefore, the limit current value determiner 15 may determine the limit value of the discharging current amount to be 160 A.

Thereafter, in Step 15B, the battery control apparatus 10 may determine whether the limit value of the discharging current amount thus determined is an adjusted limit value.

In the example illustrated in FIG. 9, the discharging current amount has been adjusted in Step 15A, as described above; therefore, the battery control apparatus 10 may determine in Step 15B that the limit current value is an adjusted limit value (Step 15B: YES), and the procedure may proceed to Step 19.

### Upward Adjustment of Limit Current Value

Returning to Step 14, a description is given of a process to be performed when it is determined that the temperature of the battery 1 will not reach the upper limit temperature Tmax, based on the predetermined Expression 7 to which the initial current value Inow (200 A in this example) is substituted for the reference value Ibase.

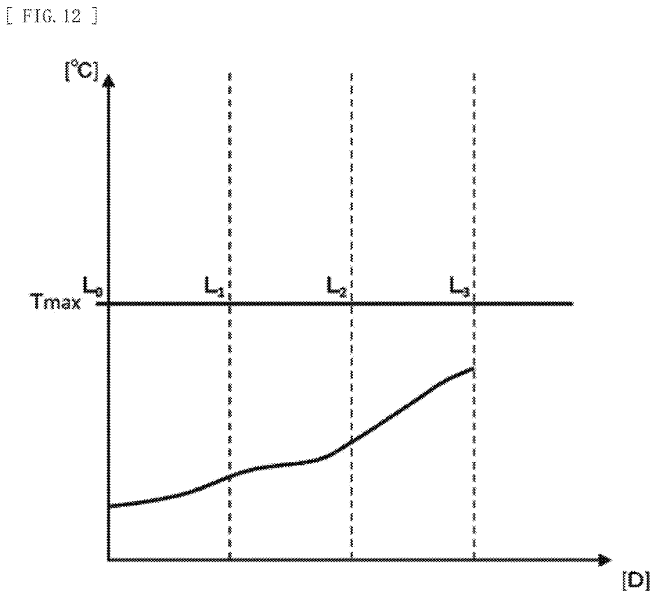

In an example illustrated in FIG. 12, it may be determined that the change in temperature of the battery 1 derived from Expression 3 described above using the initial current value Inow (200 A in this example) as the reference value Ibase will not reach the upper limit temperature Tmax (Step 14: NO). In such a case, it may be determined in the subsequent Step 15B that the limit current value has not been adjusted (Step 15B: NO), and the battery control apparatus 10 may execute the process of adjusting the limit current value (relaxation of the limit) as much as possible.

In Step 16, the battery control apparatus 10 may perform an upward adjustment process on the limit current value for the non-downward zone. In the example illustrated in FIG. 12, the limit current value determiner 15 may substitute the initial current value Inow for the reference value Ibase in the following predetermined Expression 8, and cause a predetermined amount of current value ΔI to be added to the reference value Ibase to thereby calculate the revised current value Irev.

Irev=Ibase+ΔI Expression 8

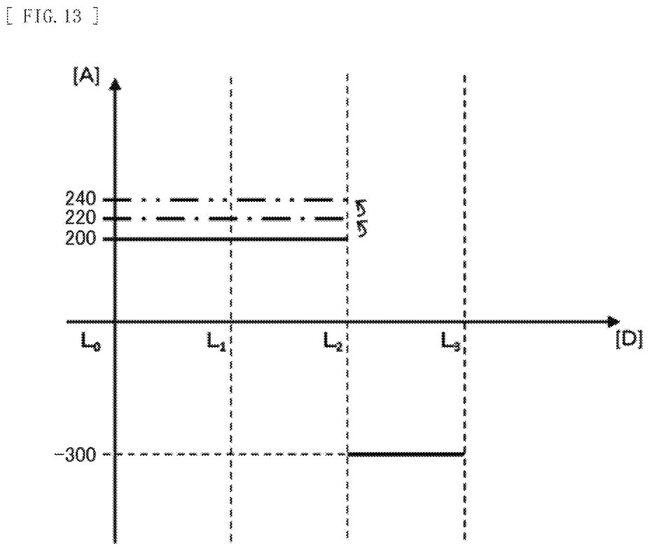

In some embodiments as illustrated in FIG. 13, the limit current value determiner 15 may adjust the discharging current amount from the initial current value Inow of 200 A set as the reference value Ibase to 220 A higher than the reference value Ibase by 20 A that corresponds to the current value ΔI, as indicated by a dashed-dotted line. Note that the current value ΔI may be any predetermined fixed value, such as 20 A or 15 A, or may be a variable that changes in accordance with repeated execution of Step 15A.

After the discharging current amount is adjusted in Step 16, the procedure may proceed to Step 17, and the battery control apparatus 10 may determine whether the temperature of the battery 1 will reach the upper limit temperature Tmax in the gradient continuous section GCS, based on the discharging current amount upwardly adjusted. In some embodiments, the battery temperature estimator 14 may estimate a change in temperature of the battery 1, based on the discharging current value upwardly adjusted to 220 A.

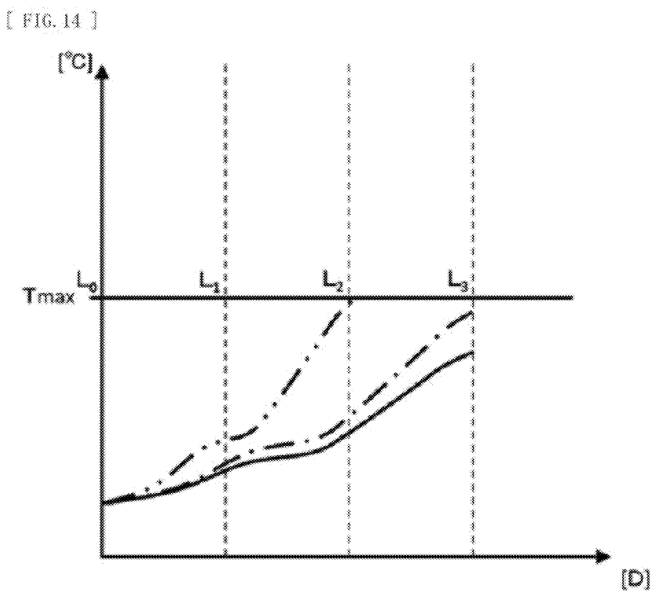

In Step 17, the battery control apparatus 10 may determine whether the temperature of the battery 1 will reach the upper limit temperature Tmax, based on the discharging current amount upwardly adjusted (220 A). In this case, as indicated by a dashed-dotted line illustrated in FIG. 14, it may be determined that the temperature of the battery will not reach the upper limit temperature Tmax (Step 17: NO), even based on the discharging current amount adjusted to 220 A; therefore, the battery control apparatus 10 may return to Step 16 to repeat the above-described process.

The limit current value determiner 15 may adjust the discharging current amount again from 220 A, which is the discharging current amount having been adjusted as the reference value Ibase, to 240 A, which is higher than the reference value Ibase by 20 A that corresponds to the current value ΔI, as indicated by a dashed-dotted line in FIG. 13.

After the discharging current amount is adjusted again in Step 16, the procedure may proceed to Step 17 again, and the battery control apparatus 10 may determine again whether the temperature of the battery 1 will reach the upper limit temperature Tmax in the gradient continuous section GCS, based on the discharging current amount upwardly adjusted (240 A in this example). In this case, as indicated by a dashed-two dotted line illustrated in FIG. 14, it may be determined that the temperature of the battery 1 will reach the upper limit temperature Tmax in the gradient continuous section GCS (Step 17: YES), based on the discharging current amount adjusted to 240 A; therefore, the limit current value determiner 15 may determine, in Step 18, the limit value determined in the immediately previous adjustment (220 A, in this example) to be the limit value of the discharging current amount.

As described above, the battery control apparatus 10 according to the present example embodiment may perform either the upward adjustment or the downward adjustment of the limit value of the discharging current, based on whether the temperature of the battery 1 will reach the upper limit temperature Tmax in the gradient continuous section GCS. In other words, the battery control apparatus 10 may be configured to, when the temperature of the battery 1 will exceed the predetermined upper limit temperature Tmax in the gradient continuous section GCS, execute the control to determine the limit value of the discharging current in the non-downward zone within the range up to the upper limit temperature Tmax by subtracting the predetermined amount of current value from the initial current value Inow, and may be configured to, when the temperature of the battery 1 will not exceed the upper limit temperature Tmax in the gradient continuous section GCS, execute the control to increase the limit value for the non-downward zone within the range of the upper limit temperature Tmax by adding the predetermined current value to the initial current value Inow.

### Case of Vehicle Speed Lower Than Lower Limit Traveling Speed

Thereafter, in Step 19, the battery control apparatus 10 may calculate a vehicle speed of the electric vehicle 100 in traveling in the upward zone X₀ of the gradient continuous section GCS, based on the limit value of the discharging current determined in the above-described step.

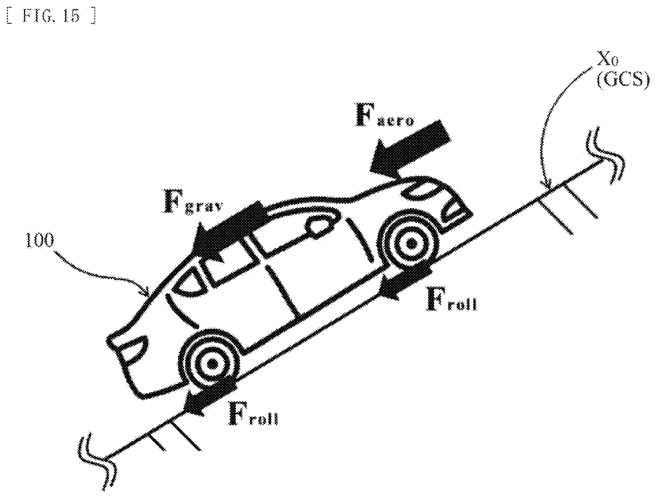

FIG. 15 schematically illustrates forces exerted on the electric vehicle 100 traveling on an upward slope at a constant speed. Note that the following description is given by way of an example in which the electric vehicle 100 travels on an upward slope at a constant speed in order to simplify the description; however, an example in which the electric vehicle 100 travels on an upward slope at a non-constant speed may be employed using another known calculation expression or conversion equation.

When the electric vehicle 100 travels on the upward slope (e.g., the upward zone X₀) as illustrated in FIG. 15, various forces may be exerted on the electric vehicle 100. Non-limiting examples of the forces exerted on the electric vehicle 100 may include the rolling resistance Froll applied from a road surface to the wheels of the electric vehicle 100, the air resistance Farero exerted on the electric vehicle 100, and the gravity Fgrav exerted on the electric vehicle 100.

Accordingly, a drive force Ftract necessary for the electric vehicle 100 to travel on the upward slope at a constant speed may be calculated by the following Expression 9:

Ftract=|Fgrav|+|Froll|+|Faero| Expression 9

Accordingly, a traveling speed v(t) of the electric vehicle 100 in traveling based on a limit value (Iₗᵢₘ) of the discharging current determined at Step 18 may be calculated by the following Expression 10, based on a relation among power, speed, and force, assuming that the electric vehicle 100 travels at a constant speed:

v=(η/Ftract)×V×Iₗᵢₘ Expression 10

Note that, in Expression 10 described above, an assumption may be made that an energy loss is generated at the time of electric power conversion in the power unit and that no loss is generated at the motor rotary shaft or another component. Further, in Expression 10 described above, “η” may represent an electric power conversion efficiency at the power unit, and “V” may represent a voltage of the battery. Note that “η” may have a value determined in advance in an experiment or simulation. Further, “V” may represent the voltage of the battery 1 calculated from a state of charge (SOC) at the time of execution of the method using a known battery model.

In some embodiments, the battery control apparatus 10 may calculate the traveling speed of the electric vehicle 100 in traveling based on the limit value (Iₗᵢₘ) of the discharging current determined in Step 18, using any known calculation expression other than the method described above.

After calculating the vehicle speed in the upward zone in Step 19, the battery control apparatus 10 may determine, in the subsequent Step 20, whether the vehicle speed thus calculated is lower than the lower limit traveling speed for the upward zone. Note that the lower limit traveling speed for the upward zone may be acquired from map data stored in a known navigator mounted in the electric vehicle 100 or a server outside the electric vehicle 100.

If it is determined in Step 20 that the vehicle speed calculated in Step 19 is not lower than the lower limit traveling speed for the upward zone (Step 20: NO), the procedure may proceed to Step 23B. In Step 23B, the battery control apparatus 10 may perform the charging and discharging control of the battery 1 in the gradient continuous section GCS, based on the limit value of the discharging current and the estimated regeneration value that are calculated as described above. When the electric vehicle 100 finishes traveling in the gradient continuous section GCS in Step 23B, the procedure may proceed to Step 24. If the system is not OFF (Step 24: NO), the procedure may return to Step 10, and the battery control apparatus 10 may repeat the above-described processing.

If it is determined in Step 20 that the vehicle speed in the upward zone is lower than the lower limit traveling speed for the upward zone (Step 20: YES), the procedure may proceed to Step 21. In Step 21, the battery control apparatus 10 may calculate backward the limit current value at that time by substituting the lower limit traveling speed for “v” in Expression 10 described above. Based on the limit current value thus calculated backward, the battery temperature estimator 14 of the battery control apparatus 10 may estimate a change in temperature of the battery 1 again using the above-described Expression 3. As described above, the battery control apparatus 10 may estimate the change in temperature of the battery in traveling in the upward zone at a vehicle speed raised to the lower limit traveling speed.

Thereafter, in Step 22, the battery control apparatus 10 may determine whether the battery 1 will reach the upper limit temperature Tmax, based on the change in temperature estimated in Step 21. If it is determined in Step 22 that the battery 1 will not reach the upper limit temperature Tmax (Step 22: NO), the procedure may proceed to Step 23B, and the battery control apparatus 10 may execute the above-described processing.

If it is determined in Step 22 that the battery 1 will reach the upper limit temperature Tmax (Step 22: YES), the procedure may proceed to Step 23A, and the battery control apparatus 10 may execute control that adjusts the regenerative current amount described below.

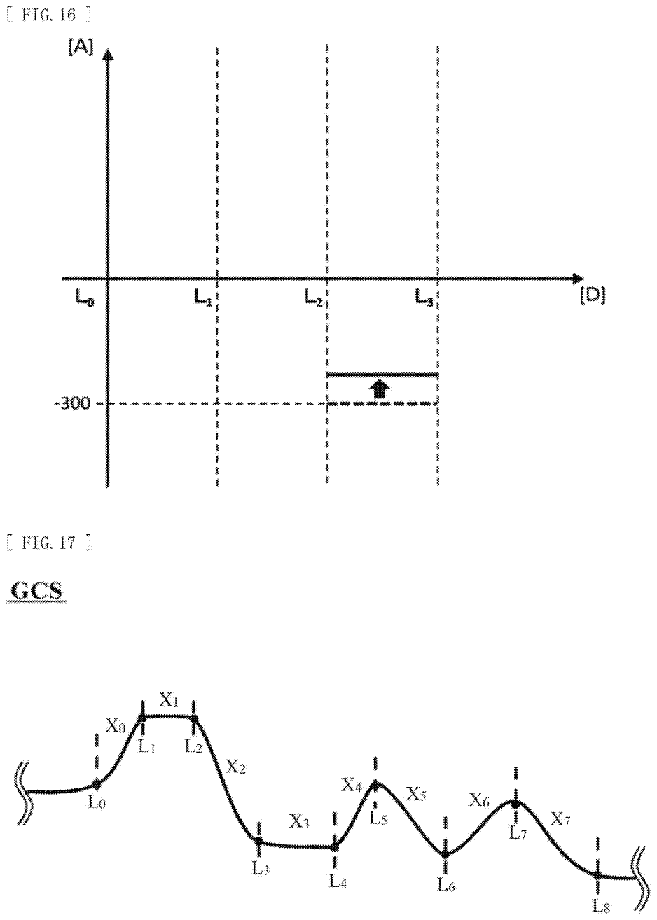

In some embodiments as illustrated in FIG. 16, the battery control apparatus 10 may execute a process of reducing a regeneration ratio for the downward zone X₂ of the gradient continuous section GCS (e.g., a process of adjusting downward the estimated regeneration value). For example, the battery control apparatus 10 may execute a process of lowering the estimated regeneration value (300 A in this example) by a predetermined ampere level (5 to 20 A).

Thereafter, the procedure may proceed from Step 23A to Step 21. In Step 21, the battery control apparatus 10 may estimate a change in temperature of the battery 1 again. Thereafter, in Step 22, the battery control apparatus 10 may determine again whether the battery 1 will reach the upper limit temperature Tmax, as described above.

If it is still determined in Step 22 that the battery 1 will reach the upper limit temperature Tmax (Step 22: YES), the battery control apparatus 10 may perform, in Step 23A, the relaxing process of reducing the regeneration ratio for the downward zone X₂ of the gradient continuous section GCS again. If it is determined in Step 22 that the battery 1 will not reach the upper limit temperature Tmax (Step 22: NO), the procedure may proceed to Step 23B, and the battery control apparatus 10 may execute the above-described process.

As described above, the battery control apparatus 10 may estimate the change in temperature of the battery in traveling in the upward zone at a vehicle speed raised to the lower limit traveling speed. If it is estimated that the battery 1 will reach the upper limit temperature Tmax, the battery control apparatus 10 may execute the relaxing process of downwardly adjusting the estimated regeneration value for the downward zone X₂. As a result, the regeneration ratio within such a range that the battery 1 will not reach the upper limit temperature Tmax may be eventually employed.

According to the battery control apparatus 10 and the battery control method of the example embodiment described above, when the electric vehicle 100 travels in the gradient continuous section GCS including one or more upward zones and one or more downward zones, it is possible to perform the charging and discharging control of the battery 1 mounted in the electric vehicle 100 economically and efficiently.

According to an existing technique, the electric power supply to (charging of) the battery is interrupted when the temperature of the battery reaches an upper limit operation value in a downward zone of the gradient continuous section. This results in limited use of regeneration braking. However, according to the method of the example embodiment of the disclosure, the battery output control may be performed in the section including the upward zone described above, without wasting energy collectable by the existing technique as heat or hydraulic pressure braking. This achieves appropriate energy management for the battery.

### Program

As described above, the battery control method may be implemented in the form of a computer-readable battery control program. The battery control apparatus 10 may be configured to read the battery control program.

The battery control program disclosed in the above-described example embodiment may be a computer program that causes, when executed by a computer, the computer to implement a method including: calculating an estimated regeneration value of a regenerative current amount to be supplied to the battery mounted in the vehicle in a downward zone of a gradient continuous section including one or more non-downward zones and one or more downward zones; tentatively determining a discharging current amount to be discharged from the battery in the non-downward zone of the gradient continuous section, with a value of current flowing from the battery before the vehicle enters the gradient continuous section set as an initial current value; and determining the limit value of the discharging current amount in the non-downward zone by adjusting the initial current value, based on a temperature rise value of the battery in the gradient continuous section determined based on the estimated regeneration value thus calculated and the discharging current amount.

In some embodiments, the battery control program may be downloaded from a known server such as a cloud server to the electric vehicle 100.

### Non-transitory Recording Medium

As described above, the non-transitory recording medium according to the example embodiment of the disclosure contains the battery control program. The battery control program causes, when executed by a processor, the processor to perform charging and discharging control of the battery mounted in the vehicle in a gradient continuous section including one or more upward zones and one or more downward zones. The battery control program includes a command that causes the processor to implement a method including: calculating an estimated regeneration value of a regenerative current amount to be supplied to the battery mounted in the vehicle in a downward zone of the gradient continuous section including one or more non-downward zones and one or more downward zones, tentatively determining a discharging current amount to be discharged from the battery in the non-downward zone of the gradient continuous section, with a value of current flowing from the battery before the vehicle enters the gradient continuous section set as an initial current value, and determining the limit value of the discharging current amount in the non-downward zone by adjusting the initial current value, based on a temperature rise value of the battery in the gradient continuous section. The temperature rise value is determined based on the estimated regeneration value thus calculated and the discharging current amount.

Non-limiting examples of the non-transitory recording medium containing the computer program may include: a magnetic medium such as a hard disk, a floppy disk, or a magnetic tape; an optical recording medium such as a compact disk read-only memory (CD-ROM), a digital versatile disk (DVD), or a Blu-ray (registered trademark); a magneto-optical recording medium such as a floptical disk; memory devices such as a RAM or a ROM; a flash memory such as a universal serial bus (USB) or a solid-state drive (SSD); and any other medium configured to hold a program.

Although some embodiments of the disclosure have been described in the foregoing by way of example with reference to the accompanying drawings, the disclosure is by no means limited to the embodiments described above. It should be appreciated that modifications and alterations may be made by persons skilled in the art without departing from the scope as defined by the appended claims. The disclosure is intended to include such modifications and alterations in so far as they fall within the scope of the appended claims or the equivalents thereof.

### Modification Examples

In the following, a description will be given of some modification examples of the battery control apparatus and the battery control method according to the example embodiments of the disclosure.

### Other Gradient Continuous Section

In the example embodiment described above, the gradient continuous section GCS may include one upward zone, one flat road zone, and one downward zone, as illustrated in FIG. 4; however, the disclosure is not limited to the example embodiment. In some embodiments, the gradient continuous section GCS may include multiple upward zones and multiple downward zones, as illustrated in FIG. 17. In some embodiments, the gradient continuous section GCS may not necessarily include the flat road zone.

In some embodiments as illustrated in FIG. 17, the gradient continuous section GCS may include upward zones X₀, X₄, and X₆ as the upward slopes, downward zones X₂, X₅, and X₇ as downward slopes, and flat road zones X₁ and X₃. Even in traveling in such a gradient continuous section GCS, the battery control apparatus 10 may adjust the limit value of the discharging current for each upward zone and the estimated regeneration value for each downward zone, as in the example embodiment described above.

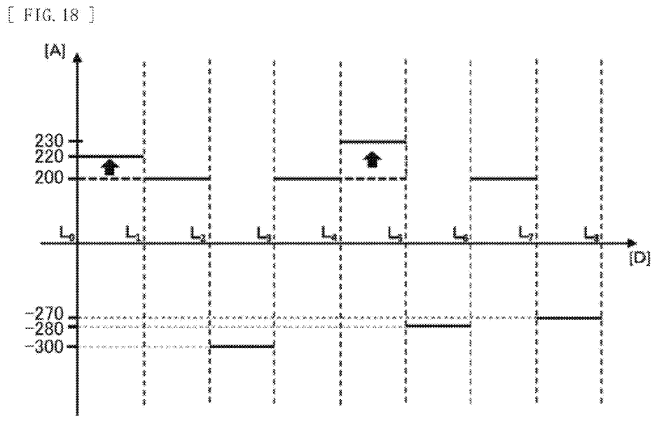

In some embodiments as illustrated in FIG. 18, the battery control apparatus 10 may adjust the limit value of the discharging current for each upward zone so that the limit values of the discharging currents are different among the upward zones of the gradient continuous section GCS. Likewise, the battery control apparatus 10 may adjust the estimated regeneration value for each downward zone so that the estimated regeneration values are different among the downward zones of the gradient continuous section GCS.

### Use of Following Vehicle Information

The battery control apparatus 10 may acquire following vehicle information on following vehicles traveling behind the electric vehicle 100 (own vehicle) including the battery control apparatus 10. In some embodiments, the battery control apparatus 10 may acquire the following vehicle information by capturing an image of the following vehicles with a known in-vehicle camera or via a known vehicle-to-vehicle communication.

If a predetermined number or more of following vehicles are traveling behind the own vehicle, the battery control apparatus 10 may execute the relaxing process (the upward adjustment described above) of the limit value of the discharging current set for the non-downward zone of the gradient continuous section GCS so that the battery 1 will not reach the upper limit temperature Tmax. In this case, the predetermined number of following vehicles may be set in advance in an experiment or simulation, depending on the driving performance of the own vehicle, for example.

It is therefore possible to perform the charging and discharging control on the battery 1 economically and efficiently, taking into consideration the following vehicles traveling behind the own vehicle.

### Use of Traffic Information

The battery control apparatus 10 may acquire traffic information indicating a congestion state such as a predicted traffic congestion at the time of passing of the electric vehicle 100 (own vehicle) including the battery control apparatus 10 through the gradient continuous section GCS. In some embodiments, the battery control apparatus 10 may acquire the traffic information via an in-vehicle communication device CD.

If it is estimated, based on the traffic information, that a predetermined number or more of other vehicles are present in the gradient continuous section GSC when the own vehicle travels therein, the battery control apparatus 10 may perform the control (the downward adjustment described above) that tightens the limit value of the discharging current set for the non-downward zone of the gradient continuous section GCS. In this case, the predetermined number of other vehicles may be set in advance in an experiment or simulation, depending on the driving performance of the own vehicle.

It is therefore possible to perform the charging and discharging control on the battery 1 even economically and effectively, taking into consideration the actual traffic condition.

According to the example embodiment and modification examples of the disclosure, it is possible to perform the charging and discharging control of the battery mounted in the vehicle economically and effectively when the vehicle travels in the gradient continuous section.

The limitations in the claims are to be interpreted broadly based on the language employed in the claims and not limited to examples described in this specification or during the prosecution of the application, and the examples are to be construed as non-exclusive.

As used in this specification and the appended claims, the singular forms “a,” “an,” and “the” include, especially in the context of the claims, are to be construed to cover both the singular and the plural, unless otherwise indicated herein or clearly contradicted by context.

Throughout this specification and the appended claims, unless the context requires otherwise, the terms “comprise”, “include”, “have”, and their variations are to be construed to cover the inclusion of a stated element, integer, or step but not the exclusion of any other non-stated element, integer, or step.

The use of the terms first, second, etc. does not denote any order or importance, but rather the terms first, second, etc. are used to distinguish one element from another.

The term “substantially”, “approximately”, “about”, and its variants having a similar meaning thereto are defined as being largely but not necessarily wholly what is specified as understood by one of ordinary skill in the art.

The term “disposed on/provided on/formed on” and its variants having the similar meaning thereto as used herein refer to elements disposed directly in contact with each other or indirectly by having intervening structures therebetween.

The battery control apparatus 10 illustrated in FIG. 1 is implementable by circuitry including at least one semiconductor integrated circuit such as at least one processor (e.g., a central processing unit (CPU)), at least one application specific integrated circuit (ASIC), and/or at least one field programmable gate array (FPGA). At least one processor is configurable, by reading instructions from at least one machine readable non-transitory tangible medium, to perform all or a part of functions of the battery control apparatus 10 illustrated in FIG. 1. Such a medium may take many forms, including, but not limited to, any type of magnetic medium such as a hard disk, any type of optical medium such as a CD and a DVD, any type of semiconductor memory (i.e., semiconductor circuit) such as a volatile memory and a non-volatile memory. The volatile memory may include a DRAM and a SRAM, and the nonvolatile memory may include a ROM and a NVRAM. The ASIC is an integrated circuit (IC) customized to perform, and the FPGA is an integrated circuit designed to be configured after manufacturing in order to perform all or a part of the functions of the battery control apparatus 10 illustrated in FIG. 1.

1. A battery control apparatus configured to be applied to a vehicle, the battery control apparatus being configured to perform charging and discharging control of a battery mounted in the vehicle in a gradient continuous section comprising one or more upward zones and one or more downward zones, the battery control apparatus comprising:
one or more processors; and
one or more memories configured to store a program to be executed by the one or more processors, wherein
the one or more processors are configured to
calculate an estimated regeneration value of a regenerative current amount to be supplied to the battery in the one or more downward zones of the gradient continuous section,
tentatively determine a discharging current amount to be discharged from the battery in a non-downward zone that is comprised in the gradient continuous section and different from the one or more downward zones, with a value of current flowing from the battery before the vehicle enters the gradient continuous section set as an initial current value, and
determine a limit value of the discharging current amount in the non-downward zone by adjusting the initial current value, based on a temperature rise value of the battery in the gradient continuous section, the temperature rise value of the battery being determined based on the estimated regeneration value thus calculated and the discharging current amount.

2. The battery control apparatus according to claim 1, wherein the one or more processors are configured to determine the limit value of the discharging current amount in the non-donward zone by adding a predetermined current value to the initial current value or subtracting the predetermined current value from the initial current value.

3. The battery control apparatus according to claim 1, wherein the one or more processors are configured to determine the limit value of the discharging current amount in the non-downward zone by multiplying the initial current value by a predetermined coefficient.

4. The battery control apparatus according to claim 2, wherein
the one or more processors are configured to,
when a temperature of the battery is to exceed a predetermined upper limit temperature in the gradient continuous section, determine the limit value for the non-downward zone within a range up to the predetermined upper limit temperature by subtracting the predetermined current value from the initial current value, and
when the temperature of the battery is not to exceed the predetermined upper limit temperature in the gradient continuous section, increase the limit value for the non-downward zone within the range up to the predetermined upper limit temperature by adding the predetermined current value to the initial current value.

5. The battery control apparatus according to claim 4, wherein
the one or more processors are configured to
acquire following vehicle information regarding following vehicles traveling behind the vehicle to which the battery control apparatus is applied, and,
when a predetermined number or more of the following vehicles are traveling behind the vehicle to which the battery control apparatus is applied, execute control that relaxes the limit value of the discharging current amount set for the non-downward zone.

6. The battery control apparatus according to claim 4, wherein
the one or more processors are configured to
acquire traffic information indicating a traffic condition at a time of passing of the vehicle to which the battery control apparatus is applied through the gradient continuous section, and,
when a predetermined number or more of other vehicles are predicted, based on the traffic information, to be present in the gradient continuous section upon traveling of the vehicle to which the battery control apparatus is applied in the gradient continuous section, execute control that tightens the limit value set for the non-downward zone.

7. The battery control apparatus according to claim 4, wherein
the one or more processors are configured to
calculate an estimated traveling speed of the vehicle in the non-downward zone, based on the limit value for the non-downward zone, and,
when the estimated traveling speed in the non-downward zone is lower than a minimum speed legally prescribed, execute control that relaxes the limit value for the non-downward zone and reduces the regenerative current amount in the one or more downward zones.

8. A non-transitory computer readable recording medium containing a computer program that causes, when executed by a computer, the computer to implement a method, the method comprising:
calculating an estimated regeneration value of a regenerative current amount to be supplied to a battery mounted in a vehicle in a downward zone of a gradient continuous section, the gradient continuous section comprising one or more upward zones and one or more downward zones,
tentatively determining a discharging current amount to be discharged from the battery in a non-downward zone that is comprised in the gradient continuous section and different from the one or more downward zones, with a value of current flowing from the battery before the vehicle enters the gradient continuous section set as an initial current value, and
determining a limit value of the discharging current amount in the non-downward zone by adjusting the initial current value, based on a temperature rise value of the battery in the gradient continuous section, the temperature rise value of the battery being determined based on the estimated regeneration value thus calculated and the discharging current amount.
